(19) United States
(12) Patent Application Publication
(10) Pub. No.: US 2016/0378633 A1
(43) Pub. Date: Dec. 29, 2016

(54) REPAIR OF FAILED FIRMWARE THROUGH AN UNMODIFIED DUAL-ROLE COMMUNICATION PORT

(71) Applicant: Intel Corporation, Santa Clara, CA (US)

(72) Inventors: Nitin V. Sarangdhar, Portland, OR (US); Mukesh Kataria, Santa Clara, CA (US); Chee Lim Nge, Hillsboro, OR (US); Basavaraj B. Astekar, Hillsboro, OR (US); Karthi R. Vadivelu, Folsom, CA (US)

(21) Appl. No.: 14/752,937

(22) Filed: Jun. 27, 2015

(51) Int. Cl. G06F 11/30; G06F 11/263; G06F 13/42

(52) U.S. Cl. CPC G06F 11/3051; G06F 13/4282; G06F 11/3027; G06F 11/302; G06F 11/2635

(57) ABSTRACT

A repair engine for a computing platform is separate from the repeatedly-rewritten storage components for software and firmware. For example, the repair engine may reside in ROM or hardware logic. Through dedicated connections to one or more controllers, the repair engine detects when any of the platform's dual-role ports (e.g., on-the-go USB ports) is connected to a host device. The repair engine responds by opening firmware-independent communication with the host device and supporting the downloading and execution (DnX) of a firmware image from the host. Because the communication is initiated independently of the firmware, even a catastrophic firmware failure is repairable without requiring a user to identify and use a specially modified port.

### FIELD

Related fields include repair of computing platforms, and more particularly recovery of critical firmware, such as system Basic Input/Output System (BIOS) from catastrophic failure.

### BRIEF DESCRIPTION OF DRAWINGS

FIGS. 1A-C are block diagrams illustrating a conceptual overview of an embodiment of the repair process.

FIGS. 2A-B illustrate asymmetric connectors in which the “host end” differs from the “peripheral end.”

FIG. 3 is a cross-functional diagram of the establishment of communication between the repair engine (RE) of a failed platform (FP) and the firmware of a working platform (WP).

FIG. 4 is a block diagram of multiple peripherals connected to a single host by hubs.

FIGS. 5A-B are block diagrams of a generic embedded controller (EC) and a repair-engine embodiment using an EC residing on a separate chip from the RE.

FIG. 6 is a block diagram of a single-chip RE arrangement powered by the power-delivery line of the host connection.

FIG. 7 is a block diagram of a single-chip RE arrangement, powered by the power-delivery line of the host connection, where the EC/SIO functions of monitoring and reporting port status are integrated into a control hub.

FIG. 8 represents an example of a port status register table.

### DETAILED DESCRIPTION

One form of catastrophic failure in computing platforms involves erasure, corruption, or some other loss of legibility in the system's firmware. Often, the platform's basic input/output system (BIOS), which may be responsible for booting the platform and handling communication between the platform and outside devices, resides on a rewritable firmware storage component.

The ability to rewrite information on the firmware storage component allows updating of the firmware without physically replacing the storage component. However, rewritable storage components may fail under a wider range of conditions than their non-rewritable counterparts such as read-only memory (ROM) or fixed-function hardware (FFH). Firmware failure may result from, for example, physical damage, miswriting, or data loss in a critical non-volatile memory module, such as a serial-peripheral-interface-bus flash memory (SPI Flash) or an embedded multimedia card (eMMC) interface that includes flash memory.

Recovery of a platform from a general failure (catastrophic or not) may include coupling the failed platform (FP) to a “working” platform (WP) that functions sufficiently to repair the failed components of the FP. The WP and FP are connected in a manner that causes the WP to act as a host, master, or server and the FP to act as a peripheral device, slave, or client.

In a case where the FP can still create and sustain a communication link with another device, diagnostics and repair may be feasible by transferring a clean firmware image from the WP to the FP over the same communication path as any ordinary download. However, in a catastrophic failure, the firmware that interprets signals to form data connections on the FP may not operate well enough to initiate communication with another device. In the most difficult cases, the FP may effectively have no firmware at all.

As a contingency for catastrophic cases, it is therefore desirable to situate a repair function separately from the FP's firmware in robust, if inflexible, storage; for example, in a Read-Only Memory (ROM) module.

To perform the diagnostic and/or repair, the FP may be connected to the WP by a data cable linking corresponding input/output (I/O) ports of the two platforms. For example, a Universal Serial Bus (USB) cable may connect a USB port on the WP to a USB port on the FP. To repair failures up to and including catastrophic failures, (1) two-way communication between the FP and the WP can preferably be established (including initial handshakes, data-rate negotiations, etc.) without requiring the FP firmware to function normally or even to be present; and (2) after communication is established, the WP preferably controls the process without relying on FP capabilities that may have failed; i.e., the WP acts as a host with the FP as its peripheral. Essentially, the connection between the FP and the WP preferably supports download-and-execute (DnX) functionality from the WP to the FP in a manner that requires little or no participation by the FP firmware. The FP is preferably not added to the communication loop until some rudiments of its function are restored.

One approach has been to modify one dedicated port on each platform with special hardware, causing the dedicated port to always treat any connected device as a host. Connecting the dedicated port on the FP to either a downstream-facing or dual-role port on the WP automatically enables the WP to act as a host and take control of the diagnostics and repair in the event of failure.

For example, one dedicated USB port on the FP may be modified with extra pins in the sampling circuitry. The extra pins may restrict the port to make only upstream-facing connections. The extra pins may also connect to a firmware-independent repair engine (RE) on an FP that senses a connected host and establishes communication with the host without involving the firmware. Certain signals (e.g., “High”) on the extra pins may confirm connection to a host and assign the FP to behave as a peripheral.

Many platforms may presently have multiple identical-looking ports that accept mechanically identical connector ends (e.g., USB). Thus, to use the dedicated-port approach, the user undertaking to connect a WP to repair firmware on an FP needs to know or discover which port is the dedicated port. The dedicated port may not be externally labeled, the extra pins may not be externally visible, and a manual including a port map for the particular FP being repaired may not be available, leaving the user to resort to trial and error. Moreover, problems can arise if the single dedicated port or its extra pins are damaged or malfunctioning.

One solution might be to make all the visually and mechanically identical ports dedicated ports, so that the firmware could be repaired through any of them. However, the versatility of the platform maybe undesirably restricted if all the ports were upstream-facing, because an increasing number of platforms are capable of acting as either hosts or peripherals. Besides, only a limited number of extra pin connections can physically fit on the SoC (system-on-chip) sampling circuitry, and this number may be less than the number of candidate ports.

Therefore, the industry would benefit from a way to initiate a peripheral-to-host connection from any port of the FP without needing to specially modify the ports.

A computing platform includes two or more external dual-role communication ports and a repair engine (RE) in a damage-resistant storage medium (e.g., ROM or hardware logic) separated from a firmware storage component. The RE's communicative connections to one or more controllers or hubs on the platform are routed to bypass the firmware storage component. The RE's capabilities include establishing and maintaining communications with the controllers.

In the event that the computing platform fails and becomes an FP, a sensor connected to one of the controllers senses when an upstream-facing physical connection is made to any of the dual-role ports. When the controller receives a message from the sensor indicating an upstream-physical connection on one of the dual-role ports, (i.e., a connection to a host which may be a WP), the controller responds by starting the RE. For example, if there is a mechanical or electrical feature that differs between the two connector ends, and the feature determines whether its end makes an upstream-facing or downstream-facing connection to a dual-role port (e.g., the grounded and ungrounded ID pins of the USB type C connector), the sensor senses the presence, absence, or properties of that feature, from which the connected controller is alerted to an upstream-facing connection.

Upon being activated, the RE causes one of its connected controllers (which may or may not be the center-connected controller) to establish communication with the host WP (handshakes, negotiations, pings, etc.) using a communication path and a process that are independent of the FP's firmware or the firmware storage component. After establishing communication, the RE causes a DnX request to be transmitted to the WP host. The WP host answers the DnX request by transmitting a copy of a stored “clean” (functioning) firmware image to the FP. The FP then writes the clean firmware image to the firmware storage component, overwriting the failed or absent portion of the firmware.

Optionally, the RE may also access diagnostic data, or monitor the progress of the clean overwrite, and send status messages or next-step requests to the WP.

Operating Principles and Context of Examples

To support the DnX processes described here on an unmodified dual-role port, the repair circuits and operating processes preferably include:

1. A protocol supporting reliable communication and action execution between the RE, the port controller, and the connection detector.

2. One or more fail-safe measures for the protocol to prevent freezes or crashes if a race condition develops on any of the communication paths during a power-up or a user action.

3. A firmware-independent indicator of the platform configuration, detectable by the RE so that it can select an appropriate algorithm for reading the clean firmware image received at the port.

4. A highly durable medium for the RE, e.g., ROM or fixed-function hardware (FFH), to make the RE likely to survive events that cause even catastrophic firmware failure.

Many of the following examples discuss dual-role USB OTG ports capable of making upstream-facing or downstream-facing connections, and asymmetric USB Type C connectors where one end designates a host, and the other end designates a peripheral. The subject matter, however, is not limited to this type of hardware. Rather, these concepts may be applied to any present or future dual-role port and compatible asymmetric connector where a detectable mechanical or electrical feature distinguishes a host end of the connector from a peripheral end.

Multi-Platform Implementation

The RE may include process information for all the intended configurations, allowing the same chip to be used in all the systems. Once installed on an individual platform, the RE selects the appropriate process information by reading strap pins or other durable, firmware-independent “readable” hardware arranged to represent the platform configuration.

Examples of platform configuration options include:

A. Port Options

1. No dual-role ports (but one or more permanently upstream-facing ports that can be connected to a host). The RE would preferably detect which port was connected, but not the type of connection because there would only be one type.

2. Only one dual-role port. The opposite of Case A.1: The RE would preferably detect whether the port was connected to a host, but not which port was connected because there is only one choice.

3. Two or more dual-role ports using on-chip port controllers (e.g., eXtensible Host Controller Interface (XHCI)). The RE would preferably detect which port was connected and whether the port was connected to a host.

4. Two or more dual-role ports using off-chip port controllers (e.g., eXtensible Host Controller Interface (XHCI)). The RE would preferably detect the same properties of the connection as in Case A.3, but the chip layout may need an inter-chip connection for the RE.

B. Connection-Detecting (CD) Controller Options (CD controller may be on-chip, off-chip, or integrated with a hub or port controller)

1. Has internal microcontroller (e.g., embedded controller (EC)). Algorithm includes communication (e.g., using an Inter-Integrated Circuit (I2C)-type protocol) with the port controller as the bus master and the CD controller as the bus slave.

2. No internal microcontroller (e.g. Super Input/Output (SIO)). Algorithm may be implemented as a hardware state machine or firmware algorithm (note: this “firmware algorithm” would be separated from, and independent of, the platform's BIOS firmware storage component).

C. Power Delivery (PD) Options

1. On-board power source (e.g., battery and charger) for CD controller, port controller, RE, or any combination.

2. Power delivered from the WP over the host connection (e.g., as in a power-delivering USB cable such as USB Type C).

Overview

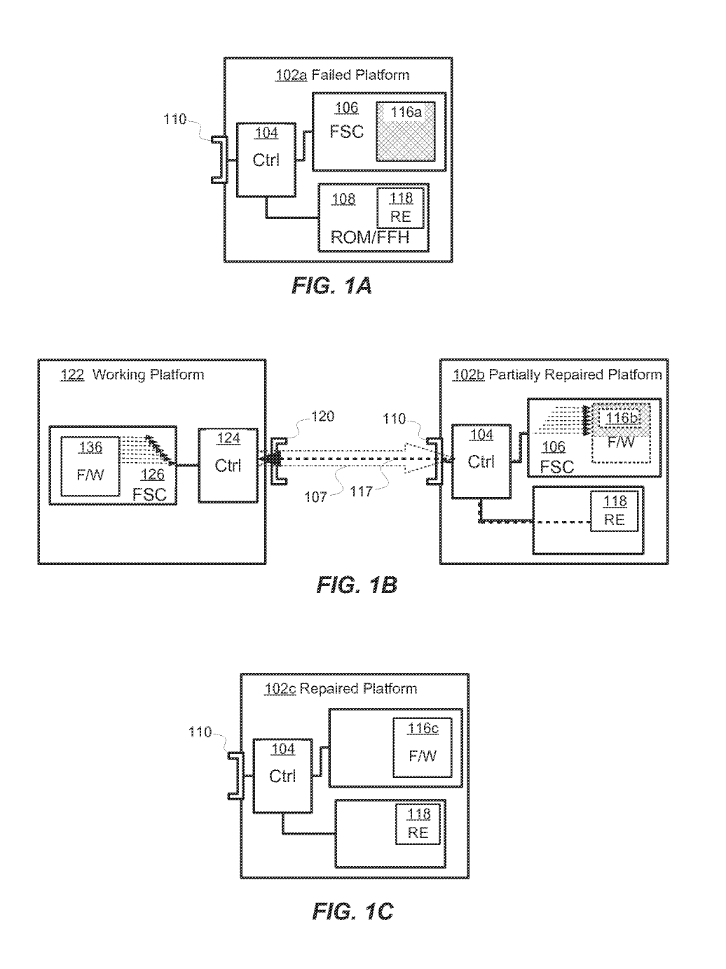

FIGS. 1A-C are block diagrams illustrating a conceptual overview of an embodiment of the repair process. FIG. 1A represents a computer platform that has failed. On conceptual FP 102a, functional blocks relevant to this overview include FP dual-role port receptacle 110, FP control system 104 (which may include multiple separate controllers), FP firmware storage component 106 including FP absent or damaged firmware 116a, and FP ROM or FFH component 108 that includes RE 118.

Before FP 102a failed, incoming messages received by FP dual-role port receptacle could be routed to either or both of FP firmware 116a and ROM or FFH component 108, and either or both of FP firmware 116a and ROM or FFH component 108 could send messages through FP dual-role port receptacle 110 to other devices. In the illustrated failed state, FP firmware 116a, absent or damaged because of the failure, may be incommunicado; i.e., it may be unable to compose any outgoing messages or analyze any incoming messages. However, the connection between FP control system 104 and ROM or FFH component 108 enables RE 118 to use FP control system 104 and FP dual-role port receptacle 110 to establish communication with an outside device that can provide a clean firmware image to replace FP absent or damaged firmware 116a.

Please note that the block diagram is a simplified functional representation. Actual physical layouts may vary. Each block may be constituted by multiple components and each connection may be constituted by multiple connections. The blocks and any of their components may or may not be co-located on the same chip, board, or other structure.

In FIG. 1B, a WP 122 storing a clean firmware image 136 on its WP firmware storage component 126 is introduced. WP port receptacle 120 is connected to FP dual-role port receptacle 110 to make WP 122 a host controlling FP 102b as a peripheral. RE 118 is triggered by the presence of the connected host WP 122, and sends communication-establishing messages 117 via FP control system 104. Through FP messages 117, RE 118 directs the handshake, data rate negotiation, and any other initiatory processes from FP 102b to form a data connection with WP 122. WP 122 responds with its own communication-establishing messages 107.

After the data connection is opened, RE 118 directs FP control system 104 to request a download of the clean firmware image 136. In some embodiments, WP 122 may have more than one firmware image stored, and RE 118 may send clarifying information, such as the platform configuration, as part of its messages 117. WP 122 responds by adding the clean firmware image 136 to its messages 107. When clean firmware image 136 is received at FP dual-role port receptacle 110, RE 118 directs FP control system 104 to write image 136 to FP firmware storage component 106, overwriting failed FP firmware 116b. in some embodiments, RE 118 may send status or progress notifications to WP 122 as part of FP messages 117.

In FIG. 1C, the repair is complete, WP 122 has been disconnected from the repaired ex-FP 102c. Repaired firmware 116c can now perform BIOS functions, including directing FP control system 104 to send messages to connected devices on FP dual-role port receptacle 110 and any other connected ports, and analyzing and responding to incoming messages on FP dual-role port receptacle 110 and any other connected ports.

For example, dual-role ports may include, without limitation, USB OTG (On-the-Go)-enabled ports. Each OTG-enabled port is capable of functioning either as a host port or as a peripheral ports. Platforms equipped with USB OTG ports may be referred to as “dual-role devices” (DRDs). For example, a laptop computer may use USB OTG to control a printer (where the laptop acts as a host) or to be controlled by a desktop computer (where the laptop acts as a peripheral. With an OTG connection, neither connected device necessarily needs to have the full Universal Host Controller Interface (UHCI) or Open Host Controller Interface (OHCI) controllers and drivers used for general-purpose USB connections, such as the USB ports built into personal computers. For example, the host and/or peripheral may have an embedded controller, which may have more limited capability than UHCl/OHCI USB controllers but can be simpler and less expensive to implement.

In some embodiments, the role (host or peripheral) of a DRD may be determined by the end of the connector engaged in the dual-role port. These connectors are asymmetric; that is, although both the “host end” and the “peripheral end” are configured to plug into the dual-role port, there is a feature difference between the two ends that can be sensed by the dual-role port.

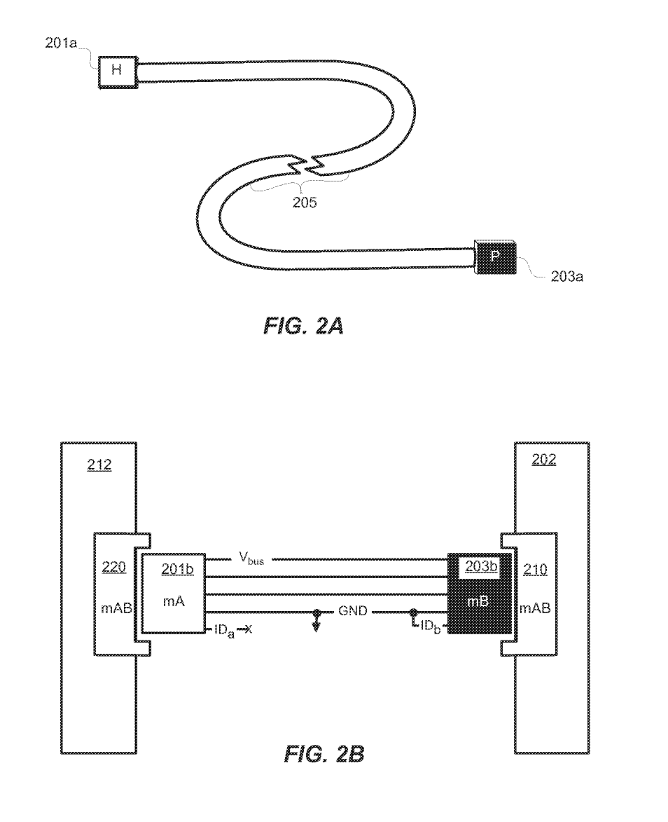

FIGS. 2A-B illustrate asymmetric connectors in which the “host end” differs from the “peripheral end.”

FIG. 2A is a conceptual drawing of a generic asymmetric connector. Cabling 205 may include any number of suitable electrical conductors (e.g., wires, braids, ribbons), and in some cases other flexible conduits such as optical fibers. Host end 201a and peripheral end 203a are both mechanically compatible with the same dual-role receptacle, but there is a distinguishing feature that can be detected by a sensor at the port, such as an extra pin, a different voltage on a pin, or a conductive ring or inset on the side.

### Examples of Implementation

FIG. 2B is a schematic illustration of a pair of dual-role ports connected by an asymmetric

Type C USB connector. A first device 202 and a second device 212 are DRDs; they can be connected to other devices as either hosts or peripherals. DRD 202's mini-AB receptacle 210 and DRD 212's mini-AB receptacle 220 are identical. (When a pair of DRDs are connected by a USB connector, one practice is to call the initial host device the “A” device and the initial peripheral device the “B” device. The modifier “initial” (directly after the connection is made) arises because some pairs of DRDs are capable of switching roles between processes or during a process without being physically disconnected).

By contrast, mini-A connector end 201b and mini-B connector end 203b have a detectable distinguishing feature: different voltages on the ID pin (near the bottoms of the connector ends on this illustration). Pin on mini-A connector end 201b is ungrounded, or floating, while pin IDb on mini-B connector end 203b is grounded by its connection to ground wire GND.

Also notable for later discussion is the “Vbus” conductor near the top of mini-A connector end 201b and mini-B connector end 203b. Vbus optionally enables one of the devices (usually the host device) to power the other device (usually a peripheral device).

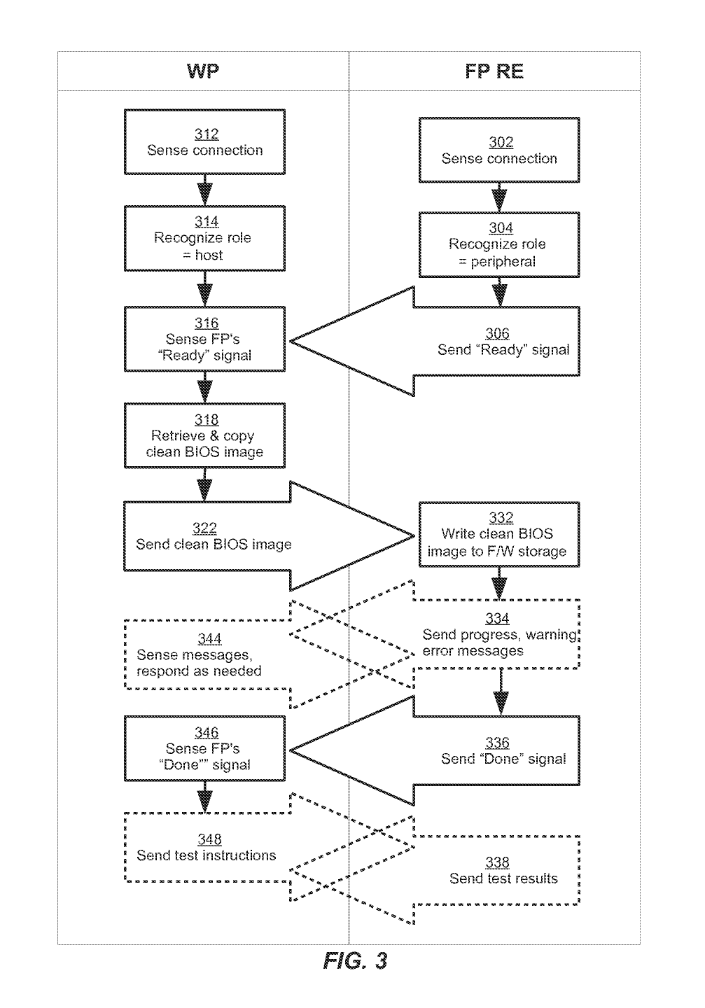

FIG. 3 is a cross-functional diagram of the establishment of communication between the repair engine (RE) of a failed platform (FP) and the firmware of a working platform (WP). At least the FP, and optionally the WP, connect via dual-role ports. Before any messages pass through the connector, the ports may sense the connector's physical presence (e.g., when a floating pin in the receptacle may become grounded by contact with a ground wire in the sensor; step 302 for the FP RE and 312 for the WP).

If the connector is asymmetric, with roles defined by the distinguishing feature, the port controllers recognize their default roles by sensing the distinguishing feature (FP RE recognizes the assignment of the peripheral role at step 304, and the WP recognizes the assignment of the host role at step 314),

After the two connected ports initiate a data connection (by handshakes, negotiations, etc.), when the FP RE is ready to receive the clean firmware image, it sends a “Ready” signal (which customarily might have been done by the firmware or some other failed component) to the WP at step 306. Optionally, information about the FP configuration may be sent with or before the “Ready” signal. The WP senses the “Ready” signal (and any accompanying configuration information) at step 316 and responds by retrieving and copying the clean BIOS image at step 318, and sending the image to the FP at step 322.

When the FP receives the clean BIOS image, the FP RE causes the image to be written to the FP firmware storage component at step 332 to replace the failed firmware. In some embodiments, the RE may write the image to the FP firmware storage component as it arrives, with little or no buffering. In some embodiments, the RE may buffer 100% of the image, and optionally run diagnostics to check for errors, before writing FP firmware storage component. Any amount of buffering between 0 and 100% may alternatively be used. Optionally, the FP RE may send progress updates, warnings, or error messages to the WP at step 334 while writing step 332 continues, and the WP may sense and respond to the messages at step 344.

When writing step 332 is completed, the FP RE (or possibly even the repaired FP firmware) sends a “Done” signal to the WP at step 336, which the WP senses and may optionally acknowledge at step 346. At this point, the WP may disengage from the FP, or it may run a series of tests on the FP's repaired BIOS (step 348 for the WP and 338 for the FP) to ensure that the firmware image, as actually installed, is uncorrupted and completely functional.

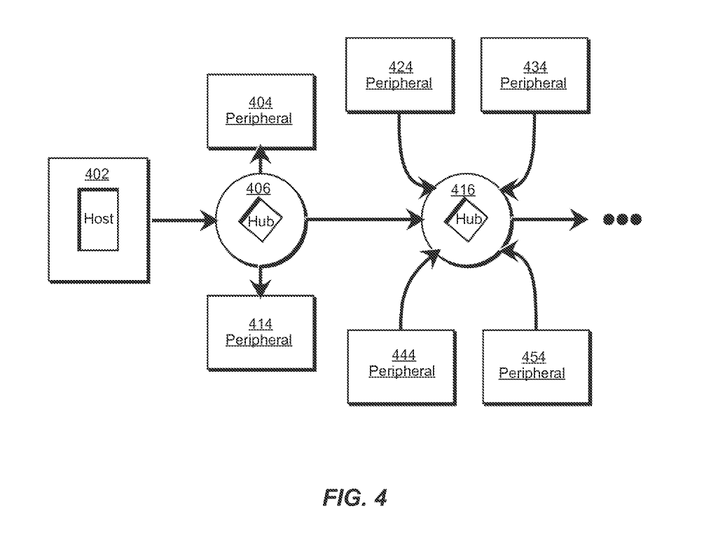

FIG. 4 is a block diagram of multiple peripherals connected to a single host by hubs. Hub 406 connects host 402 to peripherals 404 and 414, and also to hub 416. Hub 416 connects hub 406, and thereby host 402, to peripherals 424. 434, 444, and 454. Hubs may be constructed for inter-chip and intra-chip connections as well as the more familiar macroscopic inter-device connections. For example, an integrated sensor hub may collect, synthesize, or synchronize multiple sensors. A platform controller hub may coordinate the actions and information requests of multiple distributed controllers.

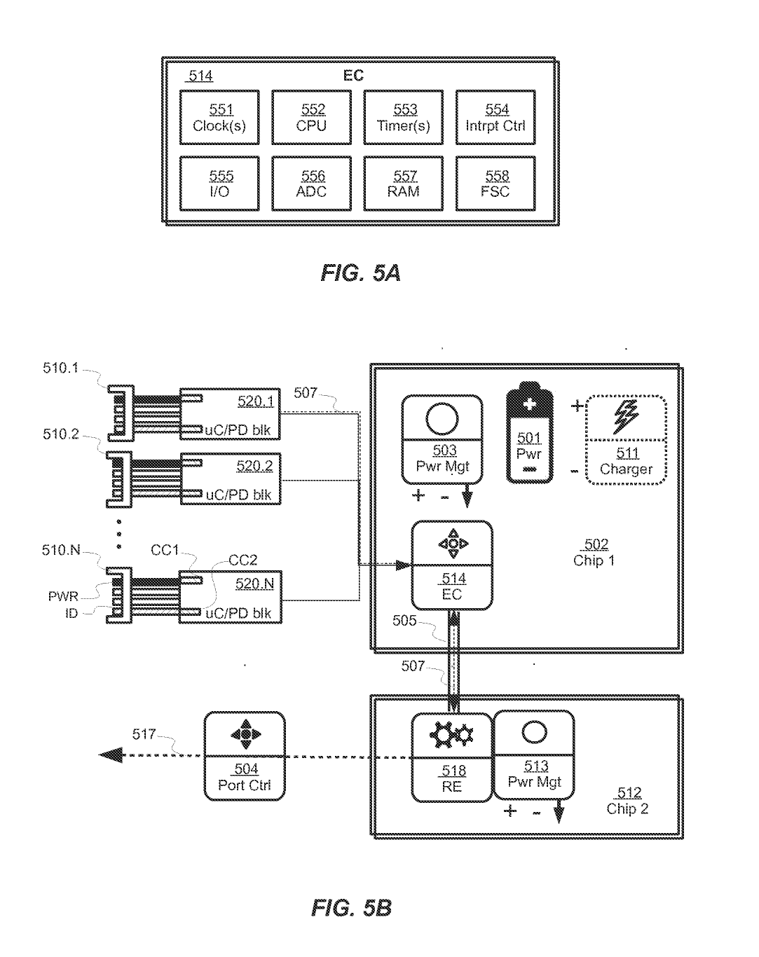

FIGS. 5A-B are block diagrams of a generic embedded controller (EC) and a repair-engine embodiment using an EC residing on a separate chip from the RE.

FIG. 5A is a block diagram of a generic embedded controller that may be encountered, for example, on a mobile platform. EC 514 may include, without limitation and in a variety of layouts:

One or more clocks 551 (system, bus, etc).

A central processing unit (CPU) 552;

One or more timers 553;

An interrupt controller 554;

Inputs and outputs (I/O) 555;

An analog-to-digital converter (ADC) 556;

Random-access memory (RAM) 557; and

A firmware storage component (FSC) 558; for example, Flash memory or other rewritable nonvolatile memory.

FIG. 5B is a block diagram of an RE embodiment in which the RE communicates with an EC located on a separate chip.

Multiple receptacles 510.1, 510.2 . . . 510.N are connection points to N dual-role ports supported by N microcontroller /power-delivery (uC/PD) blocks 520.1, 520.2 . . . 520.N, where N is a number that may be chosen according to expected use cases, sometimes with a maximum imposed by space and node size or by an applicable standard. Like USB type C connectors, these ports include, without limitation, a power delivery pin PWR, an ID pin ID that identifies whether an engaged connector end will cause the port to initially act as an upstream-facing port on a peripheral or as a downstream-facing port for a host.

The port connection status (connectedness and role) can be senses from CC pins CC1 and CC2, but RE 518 (e.g., a Converged Security and Manageability Engine (CSME)) may not be able to access the port connection status directly, for example because it is on a separate chip. Instead, EC 514 monitors the uC/PD blocks 520.1, 520.2 . . . 520.N for a “port X is connected to host” port connection status message 507 and writes it in a register accessible to RE 518.

When RE 518 reads the register and finds that some “port X is connected to host,” it requests port controller 504 (e.g., an XHCI controller, a display controller, or both).

Power may be provided by a power source (e.g., a battery 501 and on-board charger 511) on the EC chip 502 or elsewhere in the package. Power for EC 514 may be managed by, e.g., a Power Management Integrated Circuit (PMIC) 503 or a discrete voltage regulator. Power for RE 518 may be managed by, e.g., a PMIC 513.

In some embodiments:

EC 514 may communicate with uC/PD blocks 520.1, 520.2 . . . 520.N using a protocol similar to the Inter-Integrated Circuit (I2C) protocol.

EC 514 may act as a bus master with uC/PD blocks 520.1, 520.2 . . . 520.N as slaves.

The inter-chip connection 505 between EC 514 and RE 518 may be a System Management bus (SMbus) link of a type often used to connect to external system-management Application-Specific Integrated Circuits (ASICs).

RE 518 may request EC 514 to gather port status information by sending a “Ready” signal to EC 514 (e.g., as-needed after receiving a notification of firmware failure).

RE 518, EC 514, uC/PD blocks 520.1, 520.2 . . . 520.N, port controller 504, power management components 503 and, if present, 513, may be powered independently of the platform's BIOS firmware storage component (not shown in FIGS. 5-7 but see, e.g., FIGS. 1A-C),

Some systems, such as desktop systems, do not have ECs but instead have Super Input/Outputs (SIOs). The most salient difference is that ECs may have internal microcontrollers that can handle software-type algorithms, while SIOs may be standard silicon hardware with no internal microcontroller. In that case, the monitoring and triggering of the RE may be embodied in a firmware-type algorithm or a hardware state machine.

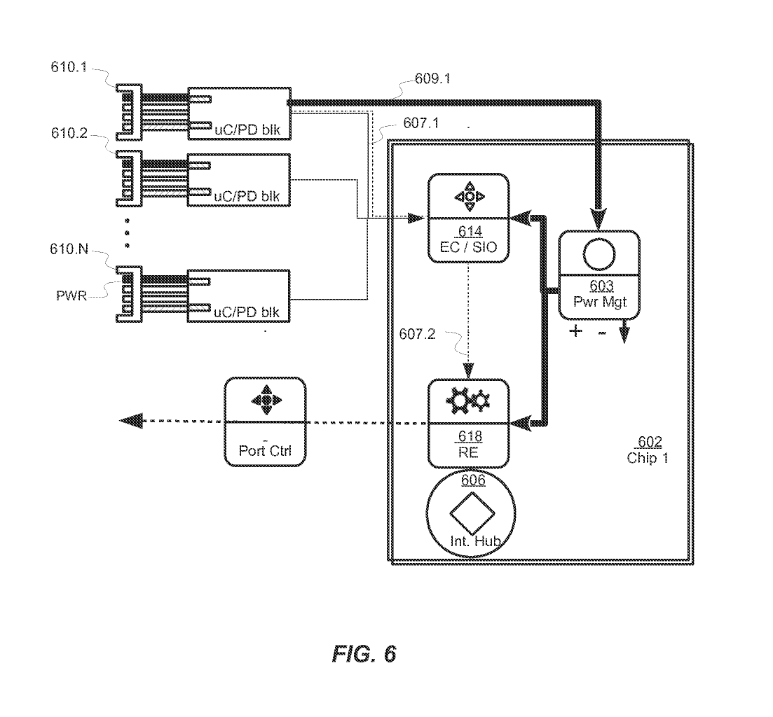

FIG. 6 is a block diagram of a single-chip RE arrangement powered by the power-delivery line of the host connection. Power 609.1 comes through the PWR pin in one of the dual-role port receptacles 610.1, 610.2 . . . 610.N and is routed to power management component 603 (e.g., a PMIC or discrete voltage regulator).

Because EC or SIO 614 and RE 618 are on a single chip 602, a single power management component 603 can manage power for both EC or SIO 614 and RE 618. For the same reason, port status messages 607.2 from EC or SIO 614 and RE 618 can travel through an on-chip trace instead of SMbus.

Some embodiments of RE 619 may be connected to an integrated hub 606, which may present more options for connecting to other on-chip components that could support RE 618.

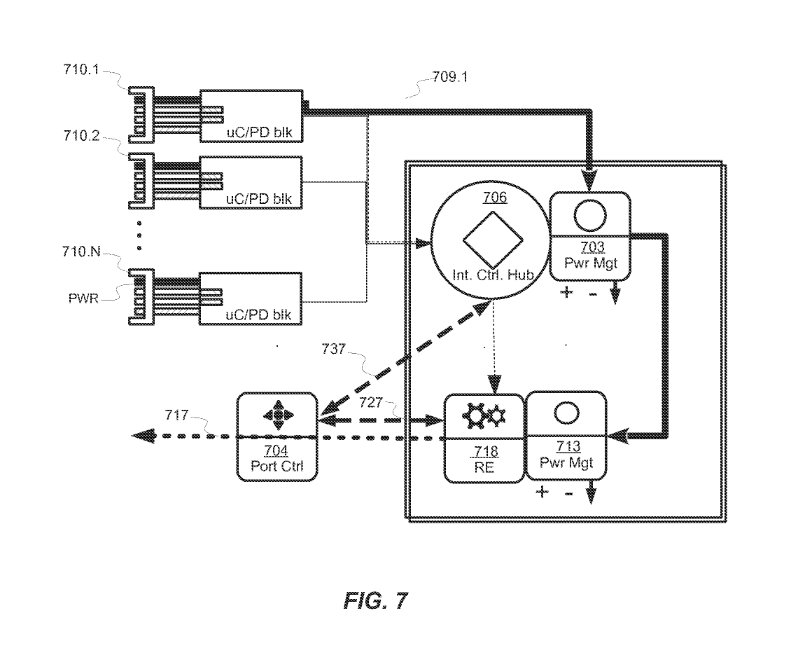

FIG. 7 is a block diagram of a single-chip RE arrangement, powered by the power-delivery line of the host connection, where the EC/SIO functions of monitoring and reporting port status are integrated into a control hub. Power 709.1 comes through the PWR pin in one of the dual-role port receptacles 710.1, 710.2 . . . 710.N and is routed to power management component 703 (e.g., a PMIC or discrete voltage regulator), which manages power to integrated control hub 706.

Parts of hub 706 poll the UC/PD blocks for connections to hosts and alert RE 718 when one is found. Afterward, hub 706 and RE 718 share control of port controller 704 through communication lines 727 and 737. During the DnX of the clean firmware image, RE 718 polls the slave-configured uC/PD blocks 720.1, 720.2 . . . 720.N. Normally uC/PD blocks 720.1, 720.2 . . . 720.N would be polled by both RE 718 and hub 706. However, the DnX of the clean firmware image is a critical task, and multi-master complexities and race conditions are preferably avoided. In some embodiments a rule is added to the software-based communication protocol that only RE 718 may poll uC/PD blocks 720.1, 720.2 . . . 720.N while a DnX process is ongoing.

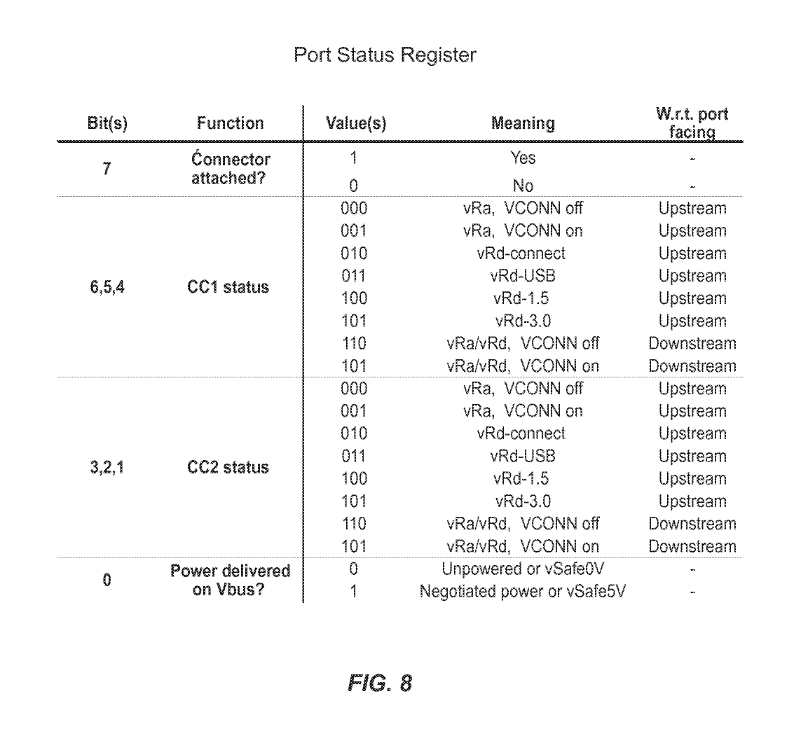

FIG. 8 represents an example of a port status register table. This register may be written to by the EC, SIO, or controller hub and read by the RE. In a system with 16 or fewer dual-role ports, the slave addresses of the ports may range from 0 to 15. The port connection status may be derived from pins 0 and 7. The status of all 16 dual-role ports could be handled by a 32-bit write block operation.

The preceding Description and accompanying Drawings describe examples of embodiments in some detail to aid understanding. However, the scope of protection may also include equivalents, permutations, and combinations that are not explicitly described herein. Only the claims appended here (along with those of parent, child, or divisional patents, if any) define the limits of the protected intellectual-property rights.

We claim:

1. A device, comprising:
a plurality of dual-role port receptacles, each connectable to a host device or a peripheral device;
a rewritable storage component having sufficient capacity for containing firmware for the device;
a non-rewritable logic component coupled to a first controller and to a second controller;
a plurality of transmitters and receivers controlled by the second controller and coupled to transmit and receive messages through each of the dual-role port receptacles; and
a sensor coupled to each of the dual-role port receptacles and positioned to sense a feature of an inserted connector end, wherein an output of the sensor is transmitted to the first controller; and
wherein at least one communication path connecting the dual-role port receptacle, the sensor, the first controller, the non-rewritable logic component, the second controller, and the dual-role port receptacle bypasses the rewritable storage component.

2. The device of claim 1, wherein the first controller and the non-rewritable logic component are located on different chips and connected to each other by a bus.

3. The device of claim 1, wherein the first controller and the non-rewritable logic component are co-located on a single chip.

4. The device of claim 1, wherein the first controller is integrated into a hub connected to the non-rewritable logic component.

5. The device of claim 1, wherein the first controller is an embedded controller.

6. The device of claim 1, wherein the first controller is an XHCI controller.

7. The device of claim 1, further comprising a hub coupled to the non-rewritable logic component.

8. The device of claim 7, wherein the hub comprises an integrated sensor hub or a platform controller hub.

9. The device of claim 7, wherein the hub comprises a microcontroller or is coupled to a microcontroller.

10. The device of claim 1, wherein a power path between a power source, power-delivery and power-management components, the first controller, the non-rewritable logic component, and the second controller bypasses the rewritable storage component.

11. The device of claim 1, wherein power is supplied to the first controller, the non-rewritable logic component, and the second controller from a connected host through one of the dual-port receptacles.

12. The device of claim 1, wherein at least one pin strap coupled to the non-rewritable logic component identifies a platform configuration of the device.

13. A system, comprising:
a first computing platform, wherein the first computing platform comprises:
a plurality of dual-role communication ports;
a firmware-storage component; and
a control system comprising:
a sensor coupled to each of the communication ports, wherein the sensor responds to a receptacle connection and responds differently to an upstream-facing connection than to a downstream-facing connection; and
at least one controller coupled to the sensor and to each of the communication ports independently of the firmware-storage component;
a second computing platform, wherein the second computing platform comprises:
a communication port capable of a downstream-facing connection;
a data-storage component containing a clean firmware image operable on the first computing platform; and
a host controller coupled to the communication port and the data-storage component; and
a connector, to connect one of the dual-role ports as an upstream-facing connection to the communication port and carry subsequent messages between the first computing platform and the second computing platform.

14. The system of claim 13, wherein the connector has a first end for making an upstream-facing connection and a second end for making a downstream-facing connection;
wherein the first end has a first feature and the second end has a second feature;
wherein a receptacle of each of the dual-role communication ports accepts the first end or the second end; and
wherein the control system detects the upstream-facing or downstream-facing nature of the connection by detecting the first feature or the second feature.

15. The system of claim 13, wherein a difference between the first feature and the second feature comprises a pin.

16. The system of claim 13, wherein a difference between the first feature and the second feature comprises a voltage drop between an identifying pin and a reference pin.

17. The system of claim 13, wherein the connector comprises a power-delivery path.

18. The system of claim 13, wherein part of the control system of the first computing platform consumes power delivered over the power-delivery path.

19. The system of claim 13, wherein the connector is a Universal Serial Bus connector comprising a differently connected ID pin on each connector end.

20. A non-transitory machine-readable information storage medium containing code that, when executed, causes an electronic component to perform actions, the actions comprising:
polling a first controller to determine whether any one of a plurality of communication ports is connected to a host device, and if so, which one;
responding to detection of the connected host device by causing a second controller to:
initiate communication with the host device through the connected port;
transmit a “download and execute” request;
receive a firmware image from the connected host device; and
write the firmware image to a non-transitory rewritable storage component;
wherein the non-transitory machine-readable information storage medium is separate from and independent of the non-transitory rewritable storage component; and
wherein at least one communication path connecting the plurality of communication ports, the first controller, the non-transitory machine-readable information storage medium, and the second controller bypasses the non-transitory rewritable storage component.

21. The non-transitory machine-readable information storage medium of claim 20, wherein the polling of the first controller is triggered by a firmware failure.

22. The non-transitory machine-readable information storage medium of claim 20, wherein the non-transitory machine-readable information storage medium comprises non-rewriteable memory.

23. The non-transitory machine-readable information storage medium of claim 20, wherein the non-transitory machine-readable information storage medium comprises fixed-function hardware.

24. The non-transitory machine-readable information storage medium of claim 20, additionally containing code that, when executed, causes a machine to perform further actions, the actions comprising routing, buffering, backing up, or otherwise assisting the writing of the firmware image to the non-transitory rewritable storage component.

25. The non-transitory machine-readable information storage medium of claim 20, additionally containing code that, when executed, causes a machine to perform further actions, the actions comprising selecting one of a plurality of stored processes of polling and responding according to criteria comprising strap-pin settings of a non-rewritable memory component.
